(19) United States
(12) Patent Application Publication
(10) Pub. No.: US 2014/0346361 A1
(43) Pub. Date: Nov. 27, 2014

(54) TIME-OF-FLIGHT PIXELS ALSO SENSING PROXIMITY AND/OR DETECTING MOTION IN IMAGING DEVICES & METHODS

(71) Applicants: Yibing M. WANG, Temple City, CA (US); Ilia OVSIANNIKOV, Studio City, CA (US); Tae-Chan KIM, Yongin-City (KR)

(72) Inventors: Yibing M. WANG, Temple City, CA (US); Ilia OVSIANNIKOV, Studio City, CA (US); Tae-Chan KIM, Yongin-City (KR)

(21) Appl. No.: 14/149,796

(22) Filed: Jan. 7, 2014

Related U.S. Application Data
(63) Continuation-in-part of application No. 13/901,564, filed on May 23, 2013.
Application No. 13/901,564 is a continuation-in-part of application No. 14/108,313, filed on Dec. 16, 2013.
(60) Provisional application No. 61/865,597, filed on Aug. 13, 2013.

(51) Int. Cl. G01S 17/08; G06F 3/042

(52) U.S. Cl. CPC G01S 17/08; G06F 3/042
USPC 250/349

(57) ABSTRACT

An imaging device has a pixel array that includes one or more depth pixels. The imaging device also includes a controller that can cause one or more of the depth pixels to image a depth of an object in a ranging mode. The controller can further cause the depth pixel(s) to image in one or more detection modes, with the appropriate control signals. The imaging device also includes a monitoring circuit that can detect a current drawn by the depth pixel(s) in the detection modes. A revert indication can be generated from the detected current. Depending on the control signals, the revert indication can serve as a proximity indication, or as a motion indication.

### CROSS REFERENCE TO RELATED PATENT APPLICATIONS

This patent application claims priority from U.S. Provisional Patent Application Ser. No. 61/865,597, filed on Aug. 13, 2013, titled: “MULTI-FUNCTIONAL IMAGE SENSOR FOR PROXIMITY SENSING, MOTION DETECTION, AND 3D DEPTH MEASUREMENT”, the disclosure of which is hereby incorporated by reference for all purposes.

This patent application is a Continuation-In-Part of co-pending U.S. patent application Ser. No. 13/901,564, filed on May 23, 2013, titled “RGBZ PIXEL ARRAYS, IMAGING DEVICES, CONTROLLERS & METHODS”, which is hereby incorporated by reference, all commonly assigned herewith.

This patent application is a Continuation-In-Part of co-pending U.S. patent application Ser. No. 14/108,313, filed on Dec. 16, 2013, which is hereby incorporated by reference, all commonly assigned herewith.

### BACKGROUND

Mobile electronic devices can be used under conditions where it may be merited to disable a touch screen, or turn off a display. Accordingly, a mobile device may have a proximity sensor, for detecting whether a user is holding it very close to his face. If the user does, the touchscreen may be disabled, to prevent inadvertent entries by the user's face and ears. Moreover, a mobile device may have a motion detector, for detecting whether it has been left alone. If it has, the display may be turned off to conserve battery power.

A challenge in the prior art is that such proximity sensors and motion detectors add to the size, weight, and cost of mobile devices.

### BRIEF SUMMARY

The present description gives instances of imaging devices, systems and methods, the use of which may help overcome problems and limitations of the prior art.

In one embodiment, an imaging device has a pixel array that includes one or more depth pixels. The imaging device also includes a controller that can cause one or more of the depth pixels to image a depth of an object in a ranging mode. The controller can further cause the one or more of the depth pixels to image in one or more detection modes, using appropriate control signals. The imaging device also includes a monitoring circuit that can detect a current drawn by the one or more depth pixels in the detection modes. A revert indication can be generated from the detected current. Depending on the control signals, the revert indication can serve as a proximity indication, or as a motion indication.

An advantage over the prior art is that a touchscreen of the device may be disabled to prevent inadvertent entries based on the proximity indication, and without requiring the size, weight, and cost of incorporating a separate proximity sensor. In addition, a display of the device may be turned off to conserve battery power based on the motion indication, and without requiring the size, weight, and cost of incorporating a separate motion detector.

These and other features and advantages of this description will become more readily apparent from the following Detailed Description, which proceeds with reference to the drawings, in which:

### BRIEF DESCRIPTION OF THE DRAWINGS

FIG. 1 is a block diagram of an imaging device made according to embodiments.

FIG. 2 is a diagram of sample components of the imaging device according to embodiments.

FIG. 3 is a diagram of a color pixel array that includes depth pixels according to an embodiment.

FIG. 4 is a circuit diagram of a sample multi-functional depth pixel made according to an embodiment.

FIG. 5A is an arrangement for a depth measurement in a ranging mode according to embodiments.

FIG. 5B is a timing diagram for sample control signals to implement the ranging mode of FIG. 5A.

FIG. 6 is a flowchart for illustrating methods according to embodiments.

FIG. 7A is an arrangement for proximity sensing (PS) in a detection mode according to embodiments.

FIG. 7B is a timing diagram for sample control signals to implement the proximity sensing of FIG. 7A.

FIG. 8 is a sample circuit diagram showing a sample current flow during the proximity sensing of FIG. 7A.

FIG. 9 is a flowchart for illustrating proximity sensing methods according to embodiments.

FIG. 10A is an arrangement for motion detection (MD) in another detection mode according to embodiments.

FIG. 10B is a timing diagram for sample control signals to implement the motion detection of FIG. 10A.

FIG. 10C is a diagram showing an embodiment of how depth pixels of the diagram of FIG. 2 can be combined to implement the motion detection of FIG. 10A.

FIG. 11 is a flowchart for illustrating motion detection methods according to embodiments.

FIG. 12 is a flowchart for illustrating combination methods according to embodiments.

FIG. 13 depicts a controller-based system for an imaging device, which uses an imaging array and a controller made according to embodiments.

### DETAILED DESCRIPTION

As has been mentioned, the present description is about imaging devices and methods where a depth pixel can provide a proximity indication, or a depth indication, or both. Embodiments are now described in more detail.

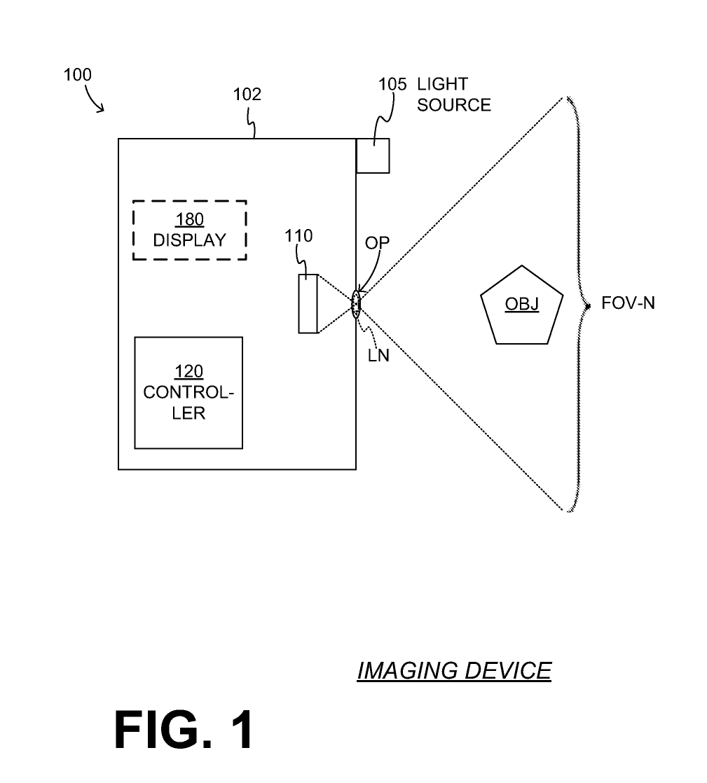

FIG. 1 is a block diagram of an imaging device 100 made according to embodiments. Imaging device 100 has a casing 102. A light source 105, such an LED, may optionally be provided on casing 102, configured to emit light. Light source 105 can be an infrared (IR) light source, and the light can be IR light.

An opening OP is provided in casing 102. A lens LN may be provided optionally at opening OP, although that is not necessary.

Imaging device 100 also has a pixel array 110 made according to embodiments. Pixel array 110 is configured to receive light through opening OP, so imaging device 100 can capture an image of an object OBJ, person, or scene. Sometimes, the image capture is assisted by light source 105. As can be seen, pixel array 110 and opening OP define a nominal Field of View FOV-N. Of course, Field of View FOV-N and object OBJ are in three dimensions, while FIG. 1 shows them in two dimensions. Further, if lens LN is indeed provided, the resulting actual field of view may be different than the nominal Field of View FOV-N. Imaging device 100 is aligned so that object OBJ, person, or scene that is to be imaged is within the actual field of view.

The pixels of pixel array 110 can capture elements of the image. In many embodiments, pixel array 110 has a two-dimensional array of pixels. The array can be organized in rows and columns.

Device 100 can render the image from the elements captured by the pixels. Optionally, device 100 also includes a display 180, which can include a screen or a touchscreen that can display the rendered image, or a version of it.

Device 100 additionally includes a controller 120, for controlling the operation of pixel array 110 and other components of imaging device 100. Controller 120 may optionally be formed integrally with pixel array 110, and possibly also with other components of imaging device 100.

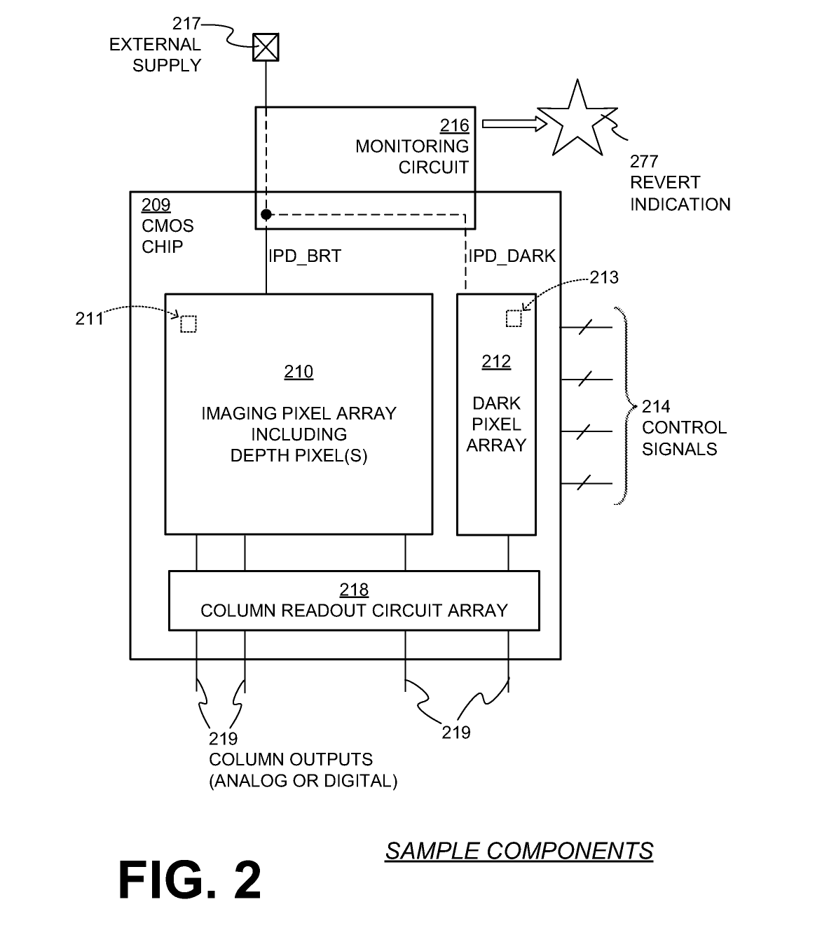

FIG. 2 is a diagram of sample components of an imaging device made according to embodiments. The components of FIG. 2 include a CMOS chip 209. CMOS chip 209 may advantageously contain a number of components.

CMOS chip 209 can have an imaging pixel array 210 that includes one or more imaging pixels. Imaging pixel array 210 may be configured to acquire an image, such as was described with reference to FIG. 1, using the imaging pixels. The imaging pixels are sometimes also called active pixels, and bright pixels. The imaging pixels can be black and white pixels or color pixels. In the latter case, the imaging pixels can be Red, Green and Blue (“RGB”). It will be appreciated that, if a single color pixel is used, ambient light can be detected for different portions of the visible spectrum.

Imaging pixel array 210 may further include depth pixels. As an example, a certain depth pixel 211 is shown. The depth pixel(s) can be caused to image a depth of an object, which means a distance of the object from the imaging device. The act of imaging a depth is also called finding a range and ranging. The depth pixel(s) can be caused to image a depth of an object while in a ranging mode.

CMOS chip 209 optionally also includes a dark pixel array 212, which contains dark pixels. As an example, a certain dark pixel 213 is also shown. Ordinarily, the dark pixels of array 212 are used to adjust the image acquired by the imaging pixels. In some instances, they have IR filters, for providing a better reference for the adjustment.

Returning briefly to FIG. 1, in some embodiments, controller 120 is capable of operating in at least two modes, a ranging mode and one or more detection modes. While in the ranging mode, controller 120 may be configured to cause at least one of the depth pixels to image a depth of an object. While in the one or more detection modes, controller 120 may be configured to cause the certain pixel to detect. Controller 120 commands by appropriate control signals.

Returning to FIG. 2, the pixels of arrays 210 and 212 receive control signals 214 from the controller, which is not shown in FIG. 2. The appropriate such control signals 214 enable the above described ranging mode, and one or more detection modes. When IR light source 105 is indeed provided, certain pixel 211 may image a reflection of the IR light, in the one or more detection modes, as well as in the ranging mode.

CMOS chip 209 also includes a column readout circuit array 218. Circuit array 218 may receive the outputs of the pixels of arrays 210, 212, and provide column outputs 219. Column outputs 219 may be in analog or digital form, and are provided to a display, to a memory, and so on.

The components of FIG. 2 also include an external supply node 217. Supply node 217 may be provided on CMOS chip 209, although that is not necessary. Supply node 217 may provide current to arrays 210 and 212, at various phases and in the various modes. The current provided to the depth pixels of array 210 while ranging is designated as IPD_BRT, and the current provided to the dark pixels of array 212 while imaging is designated as IPD_DARK.

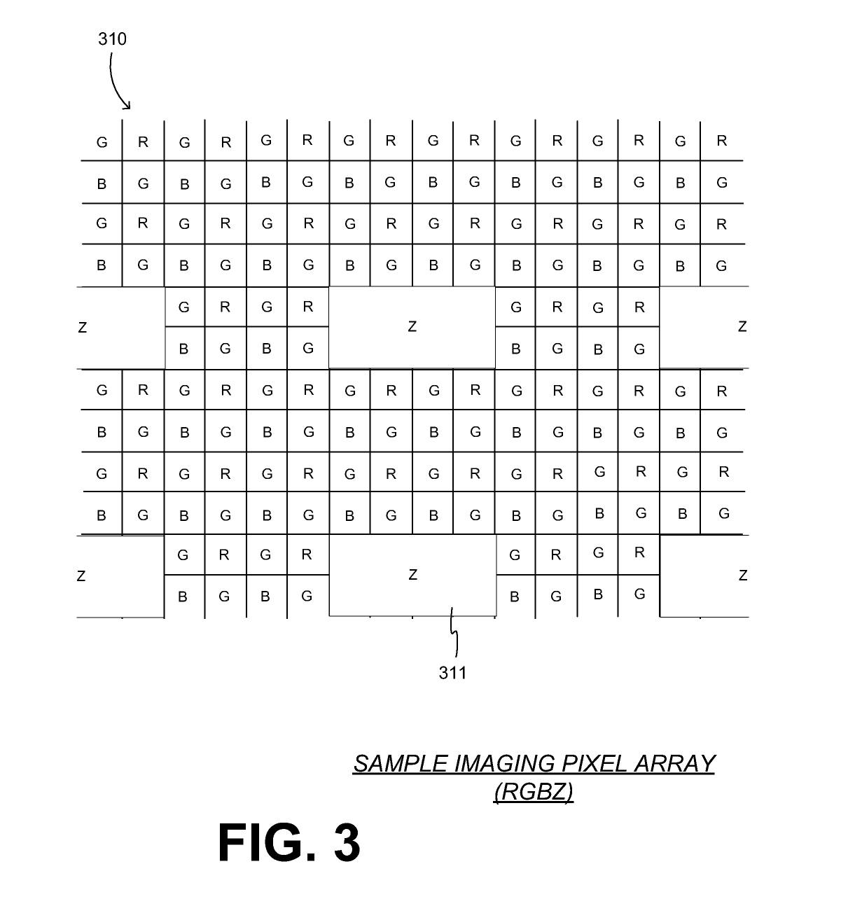

The components of FIG. 2 further include a monitoring circuit 216. Monitoring circuit 216 may be provided on or off CMOS chip 209, or a portion can be provided on CMOS chip 209 and another portion off. Monitoring circuit 216 can be configured to detect a current drawn by certain pixel 211 in the detection mode, namely current IPD. In some embodiments, the array has a group of depth pixels, i.e., depth pixels additional to the certain depth pixel 211. An example will be seen later, with reference to FIG. 3. In such embodiments, monitoring circuit 216 can be configured to detect currents drawn by a plurality of the depth pixels in the entire group, not just to certain depth pixel 211. In some embodiments, the detected current includes a difference between current IPD_BRT drawn by certain pixel 211, and simultaneously drawn current IPD_DRK by dark pixel 213.

The current is shown as being supplied from supply node 217 to array 210, and also to array 212, though monitoring circuit 216 with dashed lines. The dashed lines are shown to facilitate comprehension. Monitoring circuit 216 may detect the total current, and/or current IPD_BRT, and/or current IPD_DARK. In addition, any part of these currents may be finally supplied to arrays 210 and 212 by a component of monitoring circuit 216. The currents supplied to arrays 210 and 212 are drawn individually by the pixels of arrays 210 and 212. An example is seen in co-pending U.S. patent application Ser. No. 14/108,313.

In some embodiments, a revert indication 277 may be generated from the detected current. For example, it may be generated from a detection signal that encodes a value of the detected current, a value of a logarithm of a value of the detected current, or other suitable parameter. In some embodiments, revert indication 277 is generated from monitoring circuit 216. In other embodiments, there are additional stages for generating revert indication 277, such as comparison with a threshold level, and so on. In some embodiments, the controller generates revert indication 277 from a signal of monitoring circuit 216.

Revert indication 277 may be embodied in any number of ways. For example, it can be a value of a signal. Or it can be a digital value stored in a memory, or a flag that is set in software.

Revert indication 277 may be used in any number of ways. For example, an imaging device according to embodiments may include an additional component, which is configured to be in one of at least two states. The component may revert from a first one of the states to a second one of the states, responsive to revert indication 277. For an example, the component could be a touchscreen, such as display screen 180 of FIG. 1. The touchscreen could be in an enabled state or a disabled state. Responsive to the revert indication, the touchscreen can transition from the enabled state to the disabled state, which means it could be disabled. For another example, the component could be a display screen, such as display screen 180 of FIG. 1. The display screen can be in a state of first brightness or a state of second brightness—in other words, be capable of having at least two different brightness values. Responsive to the revert indication, the display screen can transition from the first brightness state to the second brightness state, in other words, change brightness.

FIG. 3 is a diagram of a color pixel array 310 made according to an embodiment. Pixel array 310 is an example of an array that could be used for imaging pixel array 210 of FIG. 2, where the pixels are color pixels. The color pixels can be Red, Green and Blue (“RGB”). The color pixels may be configured to acquire an image, such as was described with reference to FIG. 1.

Pixel array 310 also has a certain depth pixel 311, which could be certain depth pixel 211. Pixel array 310 also has additional depth pixels. All the depth pixels are designated as “Z”. Only one depth pixel is required to be used in a ranging mode, but more than one can be used.

The depth pixels could be made as is known in the art. In the particular embodiment of FIG. 3, it will be observed that a single depth pixel Z may occupy more space than a single color pixel R, G or B. More details about it are given in incorporated co-pending U.S. patent application Ser. No. 13/901,564.

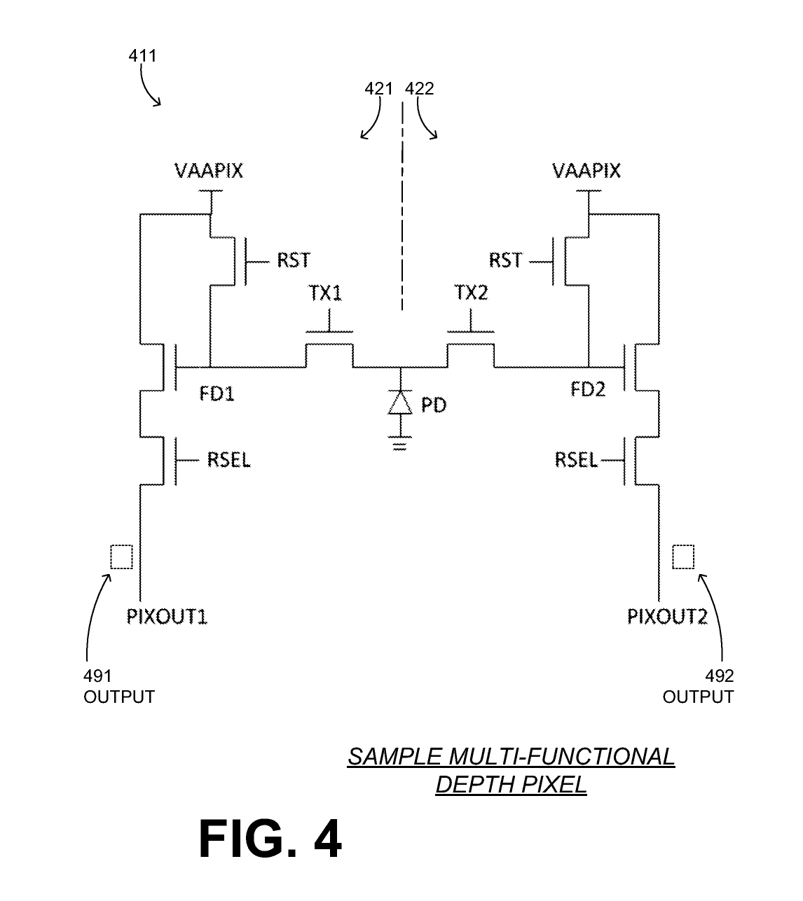

FIG. 4 is a circuit diagram of a sample multi-functional depth pixel 411, which is made according to an embodiment. The depth pixel of FIG. 4 could be pixel 311 of FIG. 3. The depth pixel of FIG. 4 has a single photodiode PD, and otherwise two pixel structures 421, 422. Each of these two pixel structures receives a voltage VAAPIX at a node, has a reset switch operated by a reset control signal RST, and is selected by a select switch that operated by a select control signal RSEL. Two transfer gates are operated by respective control signals TX1, TX2, accumulate charge on respective floating nodes FD1, FD2, and ultimately result in two respective output lines PIXOUT1, PIXOUT 2. It will be recognized that control signals RSEL, RST, TX1, TX2 could be control signals 214 of FIG. 2.

Depth pixel 411 will produce outputs 491, 492. Outputs 491, 492 are shown when they are initially produced on respective output lines PIXOUT1, PIXOUT 2. At that time, outputs 491, 492 are analog signals, but may be converted to digital signals, be stored in a memory, and so on. As will be appreciated later in this document, depth pixel 411 is multifunctional, which means that in some instances outputs 491, 492 will be called by different names depending on the mode that the depth pixel was in, when they were produced. So, these outputs could be called Time-Of-Flight (TOF) outputs when depth is imaged, Proximity Sensing (PS) outputs when proximity is detected, and Motion Detection (MD) outputs when motion is detected.

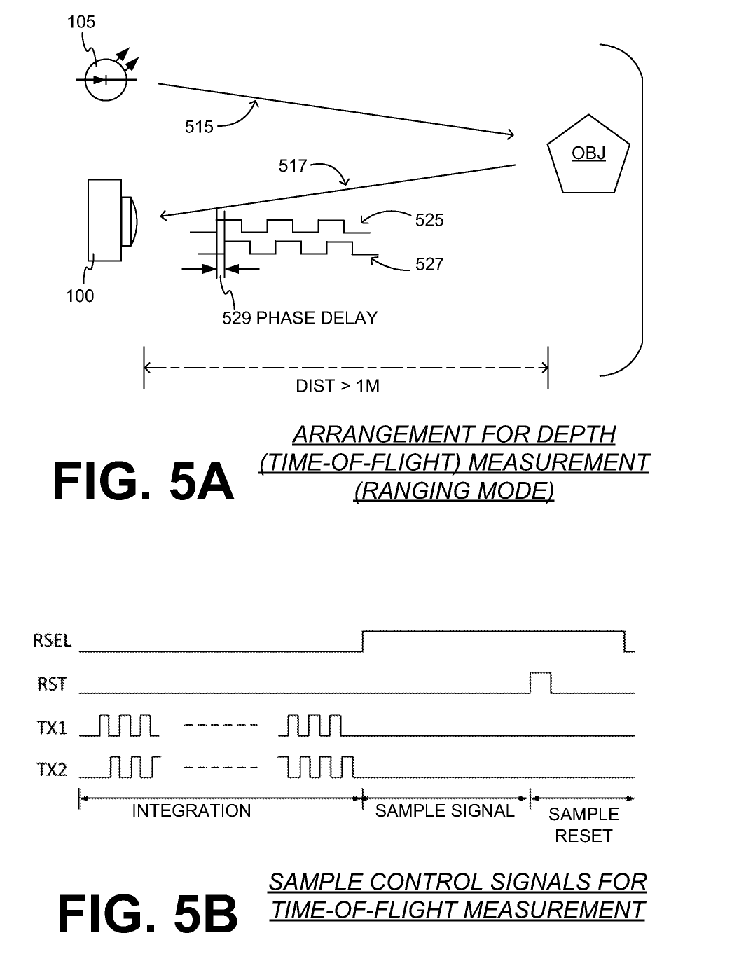

FIG. 5A is an arrangement for a depth measurement in a ranging mode according to embodiments. Imaging device 100 is at a distance of more than 1 m away from object OBJ, and usually up to 7.5 m. Light source 105, which is typically attached to the housing of imaging device 100, is shown artificially separated from imaging device 100, only for clarity of the ray diagram. For ranging, light source 105 operates at a high intensity, consuming at least 10 mW, and typically several hundred mW. Light source 105 transmits rays, such as ray 515, towards object OBJ. Rays reflected from object OBJ, such as ray 517, travel towards imaging device 100 and are imaged by at least one depth pixel of array 110.

Reflected ray 517 can be used for range finding. More particularly, the IR light in ray 515 can be modulated, for example according to waveform segment 525. A suitable modulation rate for a distance of 1 m to 7.5 m is 20 MHz. Accordingly, the IR light in ray 517 would also be modulated, for example according to waveform segment 527. Waveforms 525, 527 have a phase delay 529, which can be detected by imaging device 100. Phase delay 529 can be used to compute the distance of imaging device 100 to object OBJ, from the known speed of light. That is why also some depth pixels are called “time-of-flight” pixels.

FIG. 5B is a timing diagram for sample control signals to implement the ranging mode of FIG. 5A. It will be observed that these are the signals if the depth pixel has a circuit as circuit 411. TX1 and TX2 are clocked complementarily, and integrate signals onto nodes FD1, FD2. At the end of integration, control signal RSEL is turned on, to select a whole row of pixels. The column readout circuit samples voltages at nodes FD1, FD2 at a signal level. Then nodes FD1, FD2 are reset by control signal RST, and then they are sampled again but this time at the reset level. The difference between the voltages at nodes FD1, FD2 at the signal level and at the reset level is also known as a time-of-flight (TOF) output. The TOF output is the acquired depth image, and it may be converted into a digital code and stored.

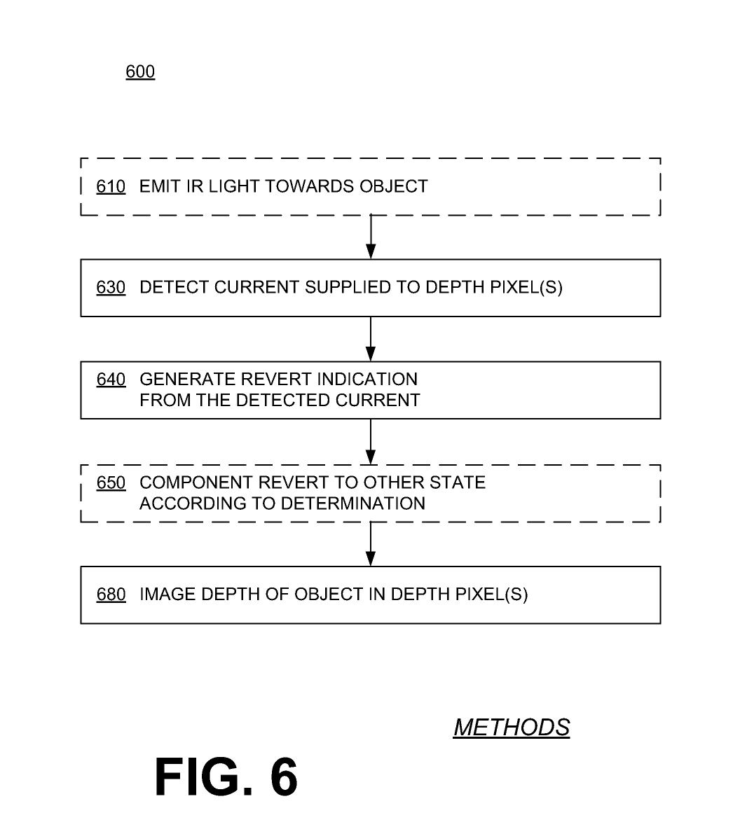

FIG. 6 shows a flowchart 600 for describing methods according to embodiments. The methods of flowchart 600 may also be practiced by embodiments described above, such as an imaging device having an array that has depth pixels.

According to an optional operation 610, light is emitted towards an object. The light can be infrared (IR).

According to another operation 630, a current drawn by the depth pixel is then detected. Operation 630 may be performed in a detection mode. More detailed examples of detection modes are provided later in this document.

In some embodiments, the imaging device further includes an infrared (IR) light source, which is configured to emit light towards the object, as was described above for IR light source 105. Then the depth can be imaged at operation 680 when the IR light source consumes a first amount of power, such as 100 mW or more. The current can be detected at operation 630 when the IR light source consumes a second amount of power. The second amount of power can be less than the first amount, in fact less than ⅕ of the first amount. The second amount of power can be less than 20 mW, less than 10 mW, and so on.

According to another operation 640, a revert indication is generated from the detected current. As also per the above, the revert indication can be generated from a detection signal encoding a value of the detected current, a value of a logarithm of the value of the detected current, or other suitable parameter.

In some embodiments, the imaging device further includes an additional component, which is configured to be in one of at least two states. In those embodiments, according to another, optional operation 650, the component reverts from a first one of the states to a second one of the states, responsive to the revert indication. The component can be a touchscreen, a screen display, and so on.

According to another operation 680, a depth of the object is imaged in a depth pixel of the array. Operation 680 may be performed in a ranging mode. If operation 610 has also been performed, then at operation 680 the depth is imaged by imaging reflected light.

The above described operations may be performed in any order. In some embodiments, it is preferred to detect current first, with weak illumination, whether in proximity sensing mode or in motion detection mode. Once the drawn current is detected as changing, one may switch to ranging mode with more IR power, for determining depth.

More particular examples of detection modes are now described. In some of the detection modes, an infrared embodiment of light source 105 is used, but consuming substantially less power than in the ranging mode.

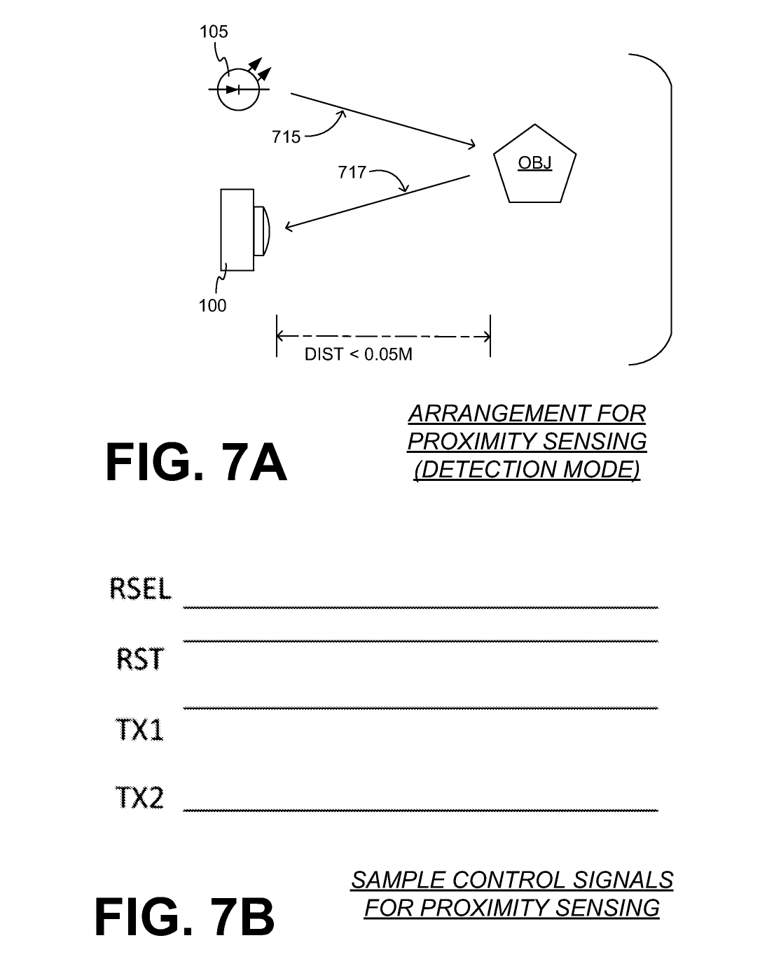

One example of a detection mode according to embodiments is proximity sensing (PS). FIG. 7A is an arrangement for proximity sensing according to embodiments. Imaging device 100 is at a distance of less than 5 cm (0.05 m) away from object OBJ, and typically closer, such as less than 1 cm. Light source 105, which is typically attached to the housing of imaging device 100, is shown artificially separated from imaging device 100, only for clarity of the ray diagram. For this detection mode, light source 105 need operate only at a low intensity, consuming less power than 10 mW, and perhaps less than 1 mW. Light source 105 transmits rays, such as ray 715, towards object OBJ. Rays reflected from object OBJ, such as ray 717, travel towards imaging device 100 and are imaged by at least one depth pixel of array 110. Reflected ray 717 can be used for the detection mode of proximity sensing. The light in ray 715 need not be modulated, but it could be.

Within the pixel array of imaging device 100, a certain one of the depth pixels is further configured to also image a reflection of the IR light from object OBJ, such as ray 717. That, even when the IR light source consumes less power than 10 mW, and thus the IR light has correspondingly less intensity than in the ranging mode.

The above described monitoring circuit is configured to detect a current drawn by the certain pixel while the IR light source consumed less power than 10 mW, which is when reflected ray 717 was being imaged. The larger the detector is, the lower the consumed IR power of light source 105 needs to be. The detector can become larger by engaging more IR-sensitive pixels. In fact, if all the available depth pixels are engaged, they may present a combined area larger than a separate standalone IR sensor in the prior art, which offers the advantage of also needing less power than in the prior art.

From the detected current, it can be determined whether object OBJ is closer to the housing of imaging device 100 than a threshold distance. In some embodiments, a revert indication is generated from the detected current, and the determination is made from the revert indication.

The determination can be used in any number of ways. In some embodiments, as also mentioned above, imaging device 100 can include an additional component that is configured to be in one of at least two states, and the component may revert from a first one of the states to a second one of the states depending on the determination. For example, the component can be a touchscreen that can be in an enabled state or a disabled state, and the touchscreen may transition from the enabled state to the disabled state depending on the determination.

Particulars are now described. FIG. 7B is a timing diagram for sample control signals to implement the proximity sensing of FIG. 7A. It will be observed that these are the signals if the depth pixel has a circuit as the circuit of depth pixel 411. Control signal RST and one of the TX gates in each depth pixel may be turned on.

Plus, what was described above with a single depth pixel can also take place with multiple depth pixels. In other words, the array could have a group of depth pixels, and the monitoring circuit could be configured to detect currents drawn by a plurality of the depth pixels in the group. In such cases, the determination can be made from the detected currents. An example is now described.

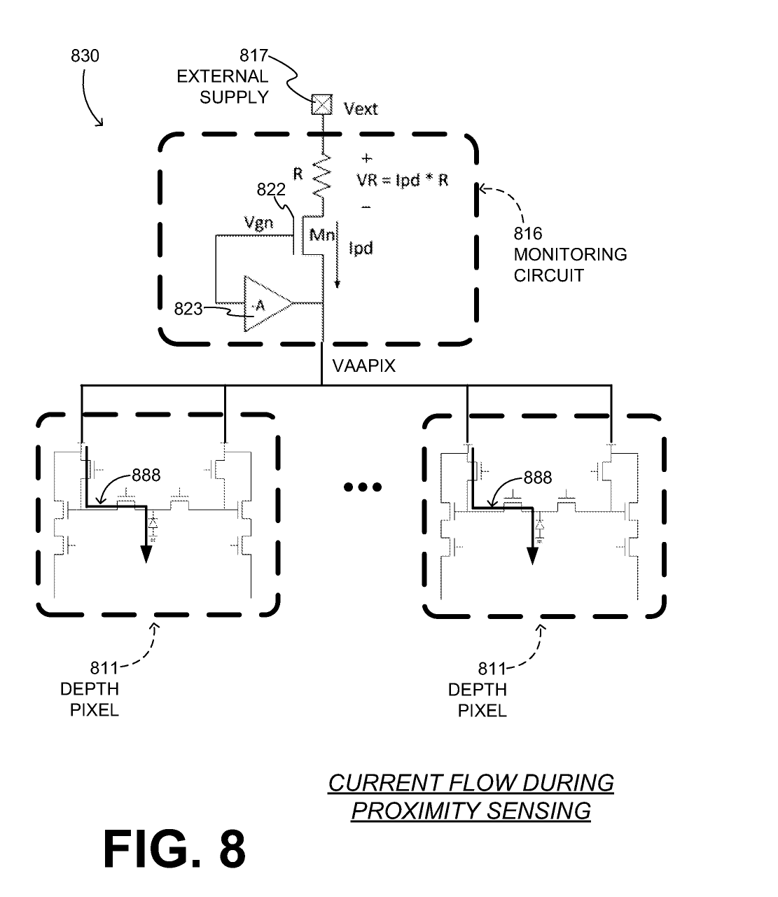

FIG. 8 is a sample circuit diagram 830. Salient aspects of FIG. 2 are repeated in sample circuit diagram 830. Depth pixels 811 may be made as depth pixel 411. An external supply node 817 supplies current to depth pixels 811 via a monitoring circuit 816. Depth pixels 811 are biased with the signals of FIG. 7B, and therefore permit current flow 888 responsive to imaging reflected ray 717. As embodied in FIG. 8, depth pixels 811 receive current IPD at a voltage VAAPIX for the total current flows 888. Monitoring circuit 816 includes a FET 822, an operational amplifier 823 and a resistor R through which passes the total supplied current IPD. The voltage drop VR across resistor R equals R*IPD, where R is also the value of the resistance of resistor R. Since value R is known, IPD can also become known from voltage drop VR.

FIG. 8 was an example of where a linear value for current IPD was encoded in detection signal VR. Other linear current-to-voltage circuits could have also been used. Alternately, for an example of dependence on a logarithm, FET 822 could be an NMOS biased at sub-threshold mode, at which point the gate voltage Vgn of that NMOS would detect IPD in logarithmic mode.

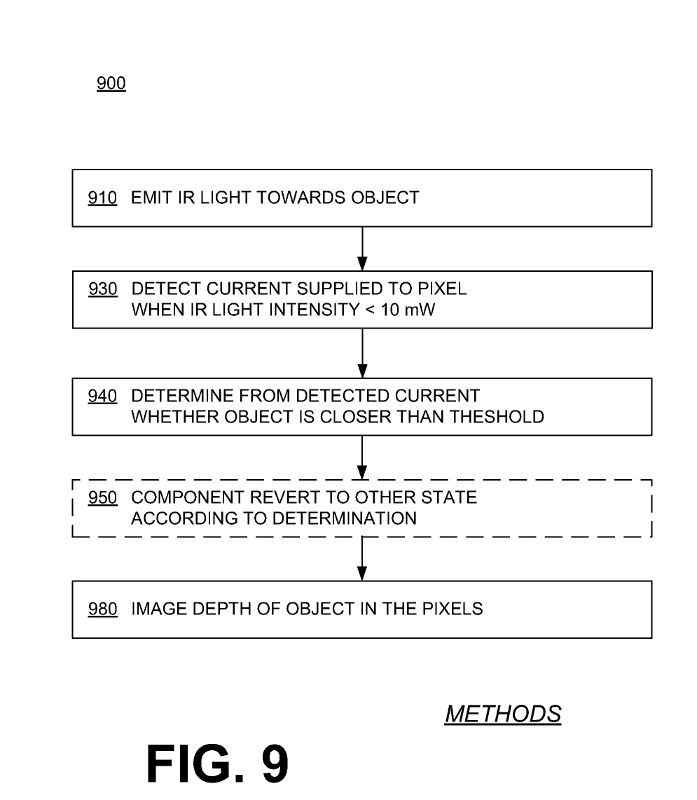

FIG. 9 shows a flowchart 900 for describing methods according to embodiments. The methods of flowchart 900 may also be practiced by embodiments described above, such as an imaging device having depth pixels, for the detection mode of proximity sensing described above.

According to an operation 910, IR light is emitted towards an object. According to another operation 930, a current drawn by the certain pixel is detected, while the IR light source consumes less power than 10 mW. Such is preferably during a detection mode, for example proximity sensing.

According to another operation 940, it is determined from the detected current whether the object is closer to the imaging device than a threshold distance. According to another, optional operation 950, a component may revert from a first state to a second state, as per the above.

According to another operation 980, a depth of the object is imaged in at least a certain one of the depth pixels, using a reflection of the IR light from the object. The depth imaging can be performed during a ranging mode.

In addition, many others of the earlier described possibilities and variations apply also to the method of FIG. 9, especially the methods of FIG. 6 and the particulars of FIG. 7A.

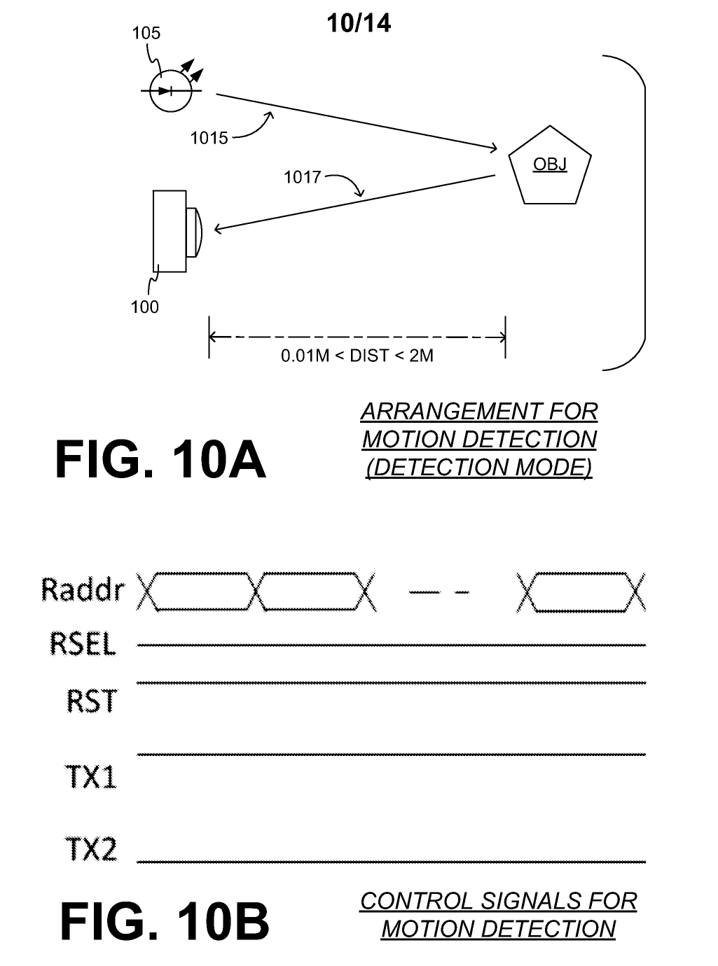

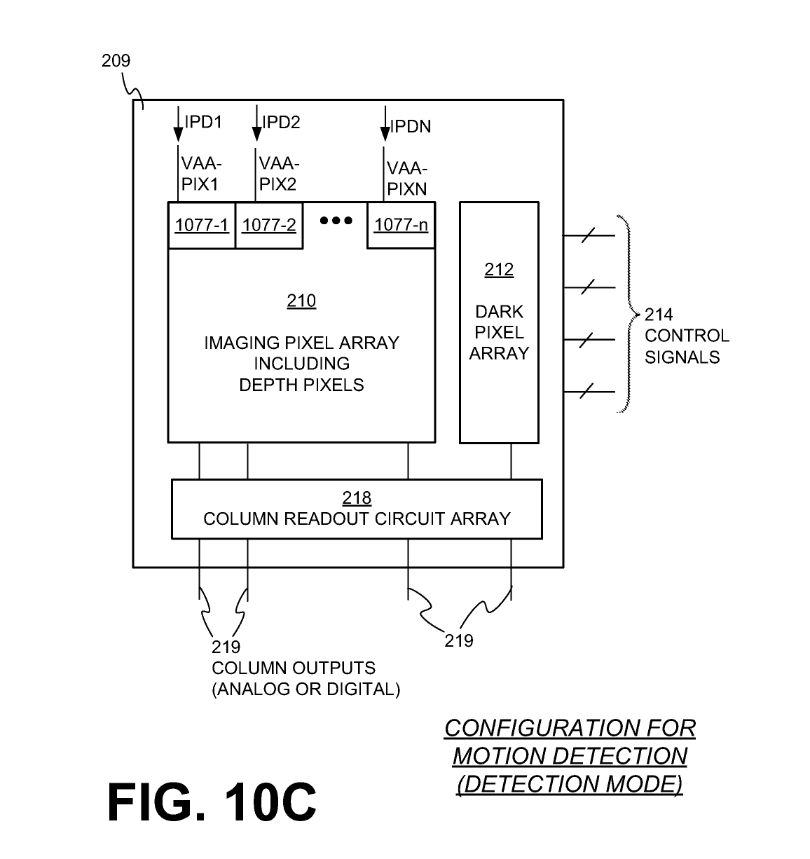

Another example of a detection mode according to embodiments is motion detection (MD). FIG. 10A is an arrangement for motion detection according to embodiments. Imaging device 100 is at a distance between 1 cm (0.01 m) and 2 m away from object OBJ, and typically about 1 m away. Light source 105, which is typically attached to the housing of imaging device 100, is shown artificially separated from imaging device 100, only for clarity of the ray diagram. For this detection mode, light source 105 need operate only at a low intensity, consuming less power than 20 mW, and perhaps just around 1 mW. As with the motion sensing, the larger the detector is, the lesser power light source 105 needs to consume.

Light source 105 transmits rays, such as ray 1015, towards object OBJ. Rays reflected from object OBJ, such as ray 1017, travel towards imaging device 100 and are imaged by at least one depth pixel of array 110. Reflected ray 1017 can be used for the detection mode of motion detection. The light in ray 1015 need not be modulated, but it could be.

Within the pixel array of imaging device 100, a certain one of the depth pixels is further configured to also image a reflection of the IR light from object OBJ, such as ray 1017. That, even when the IR light source consumes less power than 20 mW, and thus the IR light has correspondingly less intensity than in the ranging mode.

The above described monitoring circuit is configured to detect a current drawn by the certain pixel while the IR light source consumed less power than 20 mW, which is when reflected ray 1017 was being imaged. The current may be detected in a first frame and in a second frame. Preferably, imaging device 100 also includes a memory that is configured to store a value of the detected current to the certain pixel in the first frame. The stored value may be used for comparison to a value of the detected current to the certain pixel in the second frame.

From a difference in the currents detected in the first frame and the second frame, it can be determined whether object OBJ is moving with respect to the housing of imaging device 100 by more than a threshold motion. The threshold motion can be set at a very small value. In some embodiments, a revert indication is generated from the difference, and the determination is made from the revert indication.

The determination can be used in any number of ways. In some embodiments, as also mentioned above, imaging device 100 can include an additional component that is configured to be in one of at least two states, and the component may revert from a first one of the states to a second one of the states depending on the determination. For example, the component can be a display screen that can be in a state of first brightness and a state of second brightness, and the display screen may transition from the first brightness state to the second brightness state depending on the determination.

Particulars are now described. FIG. 10B is a timing diagram for sample control signals to implement the motion detection of FIG. 10A. It will be observed that these are the signals if the depth pixel has a circuit as the circuit of depth pixel 411.

Plus, what was described above with a single depth pixel can also take place with multiple depth pixels. In other words, the array could have a group of depth pixels, and the monitoring circuit could be configured to detect currents drawn by a plurality of the depth pixels in the group. In such cases, the determination can be made from the detected currents. In some embodiments, the depth pixels in the plurality are arranged in a rectangle within the array. An example is now described.

FIG. 10C is a diagram showing an embodiment of how depth pixels of the diagram of FIG. 2 can be combined to implement the motion detection of FIG. 10A. The depth pixels can be combined in rectangles 1077-1, 1077-2, . . . , 1077-n. Any imaging pixels, such as color pixels among the depth pixels, need not participate. Each rectangle can be thought of as an X-by-Y super-pixel, while the effect is that the resolution of the whole array is reduced. Each super-pixel can be made from X adjacent columns, by shorting their VAAPIX together.

Control signals 214 can be as in FIG. 10B. Y rows are selected, and one TX gate plus one or both RST gates can be turned on. Rectangles 1077-1, 1077-2, . . . , 1077-n each receive respective currents IPD1, IPD2, IPDN, at respective voltages VAAPIX1, VAAPIX2, VAAPIXN. Currents IPD1, IPD2, IPDN are due to the photodiodes working in the motion detection mode, and can be measured for the super-pixels linearly or logarithmically as per the above.

In the example of FIG. 10C, there are multiple rectangles 1077-1, 1077-2, . . . , 1077-n. In fact, there can be a single rectangle, where not all the depth pixels are used. Alternately, the single rectangle can be entire array 210, and the plurality of the depth pixels that are used are all the depth pixels in the array.

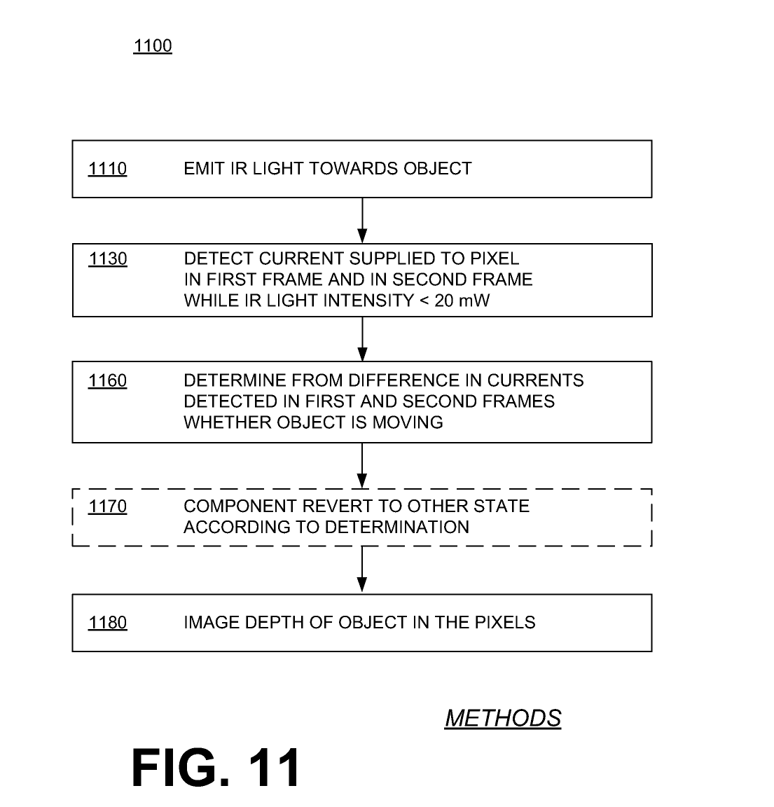

FIG. 11 shows a flowchart 1100 for describing methods according to embodiments. The methods of flowchart 1100 may also be practiced by embodiments described above, such as an imaging device having depth pixels, for the detection mode of motion detection described above.

According to an operation 1110, IR light is emitted towards an object. According to another operation 1130, a current drawn by the certain pixel is detected, while the IR light source consumes less power than 20 mW. Such is preferably during a detection mode, for example motion detection. There are at least two currents detected this way, one in a first frame and one in a second frame that follows the first frame. Preferably, a value of the detected current in the first frame is stored, for later comparison to a value of the detected current in the second frame.

According to another operation 1160, it is determined whether the object is moving with respect to the imaging device. The determination can be made from a difference in the current detected in the first frame, and in the current detected in the second frame. If there is at least an appreciable difference, then the inference is that there is motion.

According to another, optional operation 1170, a component may revert from a first state to a second state, as per the above. In addition, many others of the earlier described possibilities and variations apply also to the method of FIG. 11, especially the methods of FIG. 6 and the particulars of FIG. 10A.

According to another operation 1180, a depth of the object is imaged in at least a certain one of the depth pixels, using a reflection of the IR light from the object. The certain pixel can be a depth pixel, and the depth imaging can be performed during a ranging mode.

Again, the order of the operations may be different. In some embodiments, in a calling mode of a telephone containing the pixel array one may enable proximity sensing, in an idle mode one can enable motion detection, and in an imaging mode one can enable depth imaging.

In preferred embodiments, all three functions are possible in a single device. For example, an array for an imaging device can have depth pixels, where a certain one of the depth pixels is configured to provide a time-of-flight (TOF) output that is the same as the depth output discussed above, and a proximity sensing (PS) output and a motion detection (MD) output. All three functions can be provided in a monolithic sensor. As per the above, the PS output and the MD output can be derived by detecting a current drawn by the certain pixel.

The certain pixel could have a photodiode, two transfer gates and two outputs. Either way, more depth pixels could be used than merely the certain pixel.

Moreover, an imaging device could have a housing, and an array as the array mentioned just above. The imaging device could have a controller that provides suitable control signals, such as controller 120. The pixels in the array can be configured to receive at least three types of control signals. The certain pixel provides the TOF output, or the PS output or the MD output depending on the type of the control signals it receives. Different types of control signals were seen in FIG. 5B (for TOF), FIG. 7B (for PS), and 10B (for MD).

The imaging device could also have one or more dark pixels. In such cases, the detected current includes a difference between the current drawn by the certain pixel and a current drawn by the dark pixel.

The device could also have an IR light source that is configured to emit IR light. The TOF output, the PS output, and the MD output could be provided also from a reflection of the IR light on an object.

Moreover, as described above, the device could have an additional component, which is configured to in a first state, or a second state, and so on. The component may revert from the first state to the second state responsive to the PS output or the MD output or both. The component may be a touchscreen that can be enabled or disabled, or a display screen that can be in a state of a first or a second brightness.

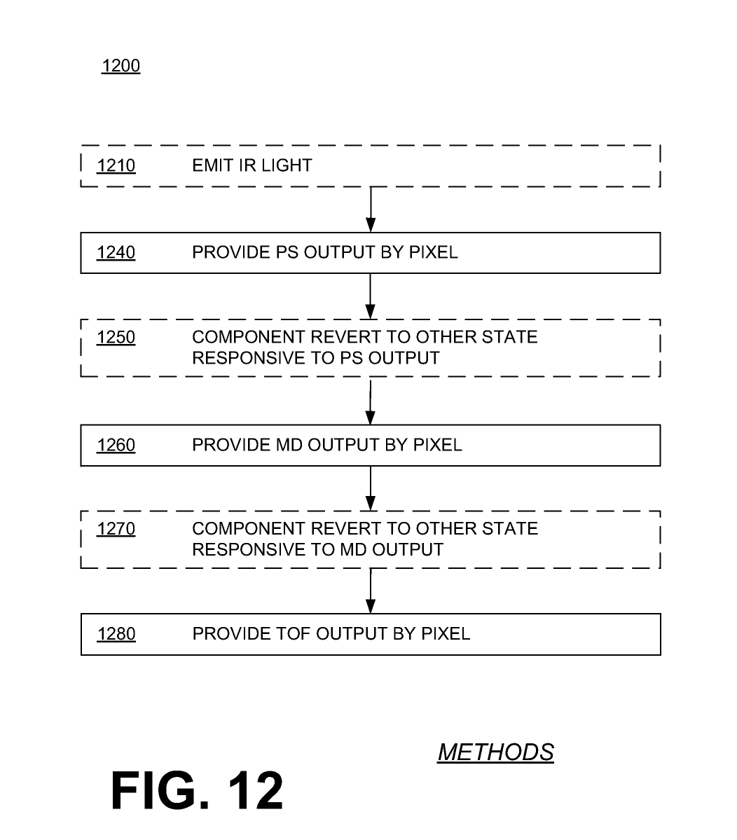

FIG. 12 shows a flowchart 1200 for describing methods according to embodiments. The methods of flowchart 1200 may also be practiced by embodiments described above, which can perform all three functions.

According to an optional operation 1210, IR light is emitted towards an object.

According to another operation 1220, a TOF output is provided from at least a certain one of the depth pixels. The TOF output is obtained by imaging a depth of the object in the certain pixel, using a reflection of the IR light from the object. The depth imaging can be performed during a ranging mode. If operation 1210 is indeed performed, then the TOF is provided also from a reflection of the IR light.

According to another operation 1240, a PS output is provided by the certain pixel. As above, the PS output can be in terms of a detected current drawn by the certain pixel, for example during the detection mode of proximity sensing. If operation 1210 is indeed performed, then the PS output is provided also from a reflection of the IR light.

According to another, optional operation 1250, a component may revert from a first state to a second state, responsive to the PS output. Examples were seen above.

According to another, optional operation 1260, a MD output is provided by the certain pixel. As above, the MD output can be in terms of a detected current drawn by the certain pixel, for example during the detection mode of motion detection. If operation 1210 is indeed performed, then the MD output is provided also from a reflection of the IR light.

According to another, optional operation 1270, a component may revert from a first state to a second state, responsive to the MD output. Examples were seen above.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, device or method.

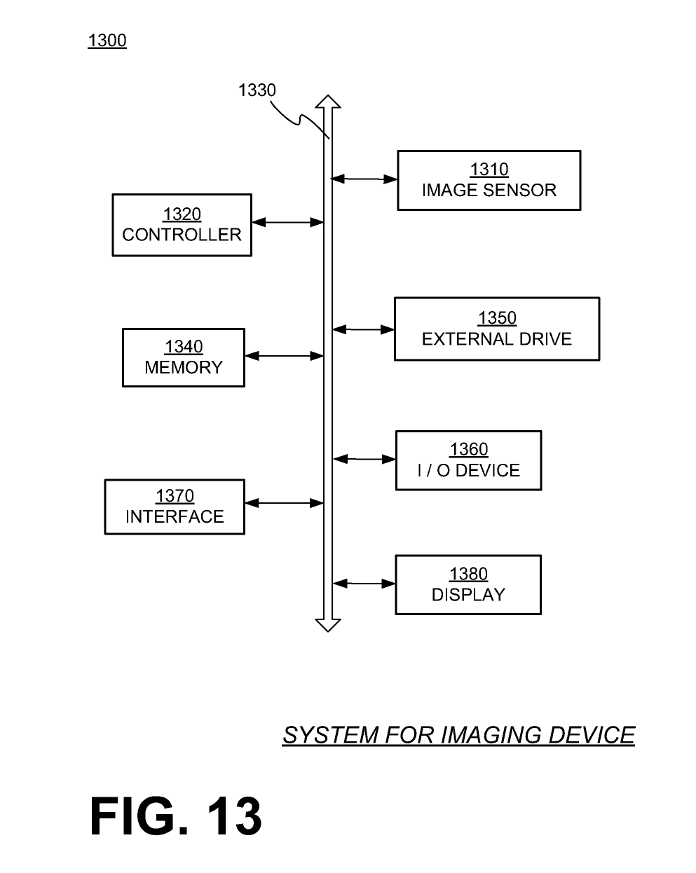

FIG. 13 depicts a controller-based system 1300 for an imaging device made according to embodiments. System 1300 could be used, for example, in device 100 of FIG. 1.

System 1300 includes an image sensor 1310, which is made according to embodiments, such as by a pixel array. As such, system 1300 could be, without limitation, a computer system, an imaging device, a camera system, a scanner, a machine vision system, a vehicle navigation system, a smart telephone, a video telephone, a personal digital assistant (PDA), a mobile computer, a surveillance system, an auto focus system, a star tracker system, a motion detection system, an image stabilization system, a data compression system for high-definition television, and so on.

System 1300 further includes a controller 1320, which is made according to embodiments. Controller 1320 could be controller 120 of FIG. 1. Controller 1320 could be a Central Processing Unit (CPU), a digital signal processor, a microprocessor, a microcontroller, an application-specific integrated circuit (ASIC), a programmable logic device (PLD), and so on. In some embodiments, controller 1320 communicates, over bus 1330, with image sensor 1310. In some embodiments, controller 1320 may be combined with image sensor 1310 in a single integrated circuit. Controller 1320 controls and operates image sensor 1310, by transmitting control signals from output ports, and so on, as will be understood by those skilled in the art.

Controller 1320 may further communicate with other devices in system 1300. One such other device could be a memory 1340, which could be a Random Access Memory (RAM) or a Read Only Memory (ROM), or a combination. Memory 1340 may be configured to store instructions to be read and executed by controller 1320. Memory 1340 may be configured to store images captured by image sensor 1310, both for short term and long term.

Another such device could be an external drive 1350, which can be a compact disk (CD) drive, a thumb drive, and so on. One more such device could be an input/output (I/O) device 1360 for a user, such as a keypad, a keyboard, and a display. Memory 1340 may be configured to store user data that is accessible to a user via the I/O device 1360.

An additional such device could be an interface 1370. System 1300 may use interface 1370 to transmit data to or receive data from a communication network. The transmission can be via wires, for example via cables, or USB interface. Alternately, the communication network can be wireless, and interface 1370 can be wireless and include, for example, an antenna, a wireless transceiver and so on. The communication interface protocol can be that of a communication system such as CDMA, GSM, NADC, E-TDMA, WCDMA, CDMA2000, Wi-Fi, Muni Wi-Fi, Bluetooth, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, MMDS, and so on.

One more such device can be a display 1380. Display 1380 could be display 180 of FIG. 1. Display 1380 can show to a user a tentative image that is received by image sensor 1310, so to help them align the device, perhaps adjust imaging parameters, and so on.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment, extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

1. An imaging device, comprising:
a housing;
an infrared (IR) light source on the housing configured to emit IR light;
an array in the housing, the array having depth pixels configured to image a depth of an object, a certain one of the depth pixels further configured to also image a reflection of the IR light from the object while the IR light source consumes less power than 10 mW;
a monitoring circuit configured to detect a current drawn by the certain depth pixel when the IR light source consumes less power than 10 mW, and
in which it is determined, from the detected current, whether the object is closer to the housing than a threshold distance.

2-4. (canceled)

5. The device of claim 1, further comprising:
an additional component configured to be in one of at least two states; and
in which the component reverts from a first one of the states to a second one of the states depending on the determination.

6. The device of claim 1, further comprising:
a touchscreen that can be in an enabled state or a disabled state, and
in which the touchscreen transitions from the enabled state to the disabled state depending on the determination.

7. The device of claim 1, in which
the array has a group of depth pixels,
the monitoring circuit is configured to detect currents drawn by a plurality of the depth pixels in the group, and
the determination is made from the detected currents.

8. The device of claim 1, in which
the monitoring circuit detects by generating a detection signal that encodes a value of the detected current.

9. (canceled)

10. (canceled)

11. The device of claim 1, in which
when the IR light source consumes less power than 10 mW, the IR light is not modulated.

12. The device of claim 1, in which
when the depth is imaged, the IR light source consumes more power than 10 mW, and the IR light is modulated.

13-20. (canceled)

21. An imaging device, comprising:
a housing;
an infrared (IR) light source on the housing configured to emit IR light;
an array in the housing, the array having depth pixels configured to image a depth of an object, a certain one of the depth pixels further configured to also image a reflection of the IR light from the object when the IR light source consumes less power than 20 mW;
a monitoring circuit configured to detect a current drawn by the certain depth pixel in a first frame and in a second frame, while the IR light source consumes less power than 20 mW, and
in which it is determined, from a difference in the current detected in the first frame and in the second frame, whether the object is moving with respect to the housing by more than a threshold motion.

22. The device of claim 21, further comprising:
a memory configured to store a value of the detected current to the certain depth pixel in the first frame for comparison to a value of the detected current to the certain depth pixel in the second frame.

23. (canceled)

24. The device of claim 21, further comprising:
a controller configured to make the determination.

25. (canceled)

26. The device of claim 21, further comprising:
an additional component configured to be in one of at least two states; and
in which the component reverts from a first one of the states to a second one of the states depending on the determination.

27. The device of claim 21, further comprising:
a display screen that can be in a state of first brightness or a state of second brightness, and
in which the display screen transitions from the first brightness state to the second brightness state depending on the determination.

28. The device of claim 21, in which
the array has a group of depth pixels,
the monitoring circuit is configured to detect currents drawn by a plurality of the depth pixels in the group, and
the determination is made from the detected currents.

29. (canceled)

30. (canceled)

31. The device of claim 21, in which
the monitoring circuit detects by generating a detection signal that encodes a value of the detected current.

32. (canceled)

33. (canceled)

34. The device of claim 21, in which
when the IR light source consumes less power than 20 mW, the IR light is not modulated.

35. The device of claim 21, in which
when the depth is imaged, the IR light source consumes more power than 10 mW, and the IR light is modulated.

36-55. (canceled)

56. An imaging device, comprising:
a housing; and
an array in the housing, the array having a plurality of depth pixels, a depth pixel in the array being configured to provide a time-of-flight (TOF) output, a proximity sensing (PS) output, and a motion detection (MD) output.

57. The array of claim 56, in which
the PS output and the MD output are derived by detecting a current drawn by the certain depth pixel.

58. The array of claim 57, further comprising:
a dark pixel, and
in which the detected current includes a difference between the current drawn by the certain depth pixel and a current drawn by the dark pixel.

59. The device of claim 56, further comprising:
an infrared (IR) light source configured to emit IR light; and
in which the TOF output, the PS output, and the MD output are provided also from a reflection of the IR light.

60. (canceled)

61. The device of claim 56, further comprising:
a controller configured to provide at least three types of control signals to the array, and
in which the certain depth pixel provides the one of the TOF output, the PS output, and the MD output depending on the type of the control signals.

62. (canceled)

63. The device of claim 56, further comprising:
an additional component configured to be in one of at least two states, and
in which the component reverts from a first one of the states to a second one of the states responsive to one of the PS output and the MD output.

64. The device of claim 56, further comprising:
a touchscreen that can be in an enabled state or a disabled state, and
in which the touchscreen transitions from the enabled state to the disabled state responsive to the revert indication.

65. The device of claim 56, further comprising:
a display screen that can be in a state of first brightness or a state of second brightness, and
in which the display screen transitions from the first brightness state to the second brightness state responsive to the revert indication.

66-95. (canceled)
